(19) United States
(12) Patent Application Publication
(10) Pub. No.: US 2016/0254828 A1
(43) Pub. Date: Sep. 1, 2016

(54) HIGH-FREQUENCY FRONT END CIRCUIT

(71) Applicant: Murata Manufacturing Co., Ltd., Kyoto (JP)

(72) Inventor: Hisao Hayafuji, Kyoto (JP)

(21) Appl. No.: 15/093,049

(22) Filed: Apr. 7, 2016

Related U.S. Application Data
(63) Continuation of application No. PCT/JP2014/074349, filed on Sep. 16, 2014.

(30) Foreign Application Priority Data
Oct. 10, 2013 (JP) 2013-212417

(51) Int. Cl. H04B 1/00; H04L 5/14; H04W 84/12; H04B 1/50

(52) U.S. Cl. CPC H04B 1/0057; H04B 1/50; H04L 5/14; H04W 84/12

(57) ABSTRACT

An antenna of a high-frequency front end circuit is connected to a duplexer and a filter. A reception-side filter of the duplexer is connected to a first reception signal output terminal. The filter is connected to the ground with a terminating resistor interposed there between. The reception-side filter is a filter which has a pass band including a frequency range of a reception signal having a first frequency band. The filter is a filter which has a pass band including a frequency range of a communication signal having a second frequency band and which has an attenuation range including the frequency range of the reception signal having the first frequency band.

### BACKGROUND

### Technical Field

The present disclosure relates to a high-frequency front end circuit which performs at least one of transmission and reception of a high-frequency signal.

Nowadays, there are various communication specifications such as a cellular system and a wireless LAN system for wireless communications, and multiple types of frequency bands are used. In order to cope with such various communication specifications and frequency bands, for example, a cellular phone device having a circuit configuration described in Patent Document 1 has been put into practical use.

The cellular phone device described in Patent Document 1 includes a cellular antenna and a wireless LAN antenna. A cellular transmission/reception circuit is connected to the cellular antenna, and a wireless LAN transmission/reception circuit is connected to the wireless LAN antenna.

Such cellular phone devices may perform cellular communication and wireless LAN communication simultaneously.

Patent Document 1: Japanese Unexamined Patent Application Publication No. 2008-228098

### BRIEF SUMMARY

However, due to diversification of communication specifications and frequency bands, currently, frequency ranges of frequency bands are close to each other. In the case where a frequency band of the cellular communication and a frequency band of the wireless LAN communication are close to each other, mutual interference is likely to occur.

In particular, in the case where a frequency range of a transmission signal of wireless LAN communication and a frequency range of a reception signal of cellular communication are close to each other, the transmission signal of the wireless LAN communication may sneak into a reception circuit for cellular communication, thereby causing deterioration in the receiving sensitivity of cellular communication.

Accordingly, the present disclosure provides a high-frequency front end circuit which is capable of, even in the case where there is a frequency band whose frequency range is close to a frequency range of a desired frequency band, reducing influence on communication using the desired frequency band.

A high-frequency front end circuit according to this disclosure includes an antenna, first and second filters, and a terminating resistor. The antenna transmits and receives communication signals having multiple frequency ranges which are close to each other. One end of the first filter is connected to the antenna, and the other end of the first filter is connected to a reception signal output terminal. The first filter has a pass band which includes a frequency range of a reception signal having a first frequency band. One end of the second filter is connected to the antenna, and the other end of the second filter is terminated. The second filter has a pass band which includes a frequency range of a communication signal having a second frequency band which is different from the first frequency band and which is used for communication in a frequency range that is close to the frequency range of the first frequency band.

With this configuration, the reception signal having the first frequency band is output to the reception signal output terminal via the first filter. The communication signal having the second frequency band is subjected to termination processing via the second filter and the reception signal is scarcely transmitted to the first filter side. Therefore, even if the frequency range of the reception signal having the first frequency band and the frequency range of the communication signal having the second frequency band are close to each other, only the reception signal having the first frequency band may be output to the reception signal output terminal. Consequently, the S/N of the reception signal having the first frequency band may be increased.

Furthermore, in the high-frequency front end circuit according to this disclosure, a frequency range of a transmission signal having the second frequency band can be in the pass band of the second filter.

With this configuration, even if the transmission signal having the second frequency band sneaks into the antenna from the outside, the transmission signal having the second frequency band is subjected to termination processing using the second filter. Accordingly, even if the transmission signal having the second frequency band at a high signal level sneaks around, the S/N of the reception signal having the first frequency band may be increased.

Furthermore, the high-frequency front end circuit according to this disclosure can have the configuration below. The high-frequency front end circuit includes a third filter that has a pass band including a frequency range of a communication signal having a third frequency band which is different from the first frequency band and the second frequency band; and a switch circuit that switches between connection of the first filter and the antenna and connection of the third filter and the antenna and switches between connection and disconnection of the second filter and the antenna. The switch circuit connects the second filter to the antenna when the first filter and the antenna are connected, and disconnects the second filter from the antenna when the third filter and the antenna are connected.

With this configuration, communication signals having different types of frequency bands may be transmitted and received using a single antenna. At this time, even if frequency bands are close to each other, only a reception signal having a desired frequency band may be output to the reception signal output terminal.

Furthermore, in the high-frequency front end circuit according to this disclosure, at least one of the first filter and the third filter may be a filter which is configured as a duplexer.

With this configuration, in the first frequency band and the third frequency band, not only reception but also transmission may be performed.

Furthermore, the high-frequency front end circuit according to this disclosure may further include a second communication antenna that transmits and receives a second communication signal; and a signal processing unit that generates a transmission signal of the second communication signal.

With this configuration, the second communication antenna which transmits the transmission signal having the second frequency band is close to the antenna, and the transmission signal having the second frequency band is likely to flow into the transmission/reception circuit for the first frequency band. However, such flowing is suppressed, and therefore the S/N of the reception signal having the first frequency band may be increased.

Furthermore, in the high-frequency front end circuit according to this disclosure, the first frequency band can be one of Band 7, Band 38, Band 40, and Band 41 of a cellular communication system, and the second frequency band is a band which adopts a Wifi system.

With this configuration, a specific example of a combination of the first frequency band and the second frequency band is provided. In this example, the first frequency band and the second frequency band are close to each other, and therefore a configuration of this application may be operated more effectively.

Even in the case where there is a frequency band which is close to a desired frequency band, communication using the desired frequency band may be ensured.

### BRIEF DESCRIPTION OF THE SEVERAL VIEWS OF THE DRAWINGS

FIG. 1 is a circuit block diagram of a high-frequency front end circuit according to a first embodiment of the present disclosure.

FIG. 2 is a diagram illustrating bandpass characteristics of each filter of the high-frequency front end circuit according to the first embodiment of the present disclosure.

FIG. 3 includes diagrams illustrating the concept of a frequency spectrum at a reception signal output terminal Prxl with a configuration of the disclosure of this application and with a configuration of related art.

FIGS. 4A and 4B include circuit block diagrams of a high-frequency front end circuit according to a second embodiment of the present disclosure.

FIG. 5 is a circuit block diagram of a high-frequency front end circuit according to a third embodiment of the present disclosure.

### DETAILED DESCRIPTION

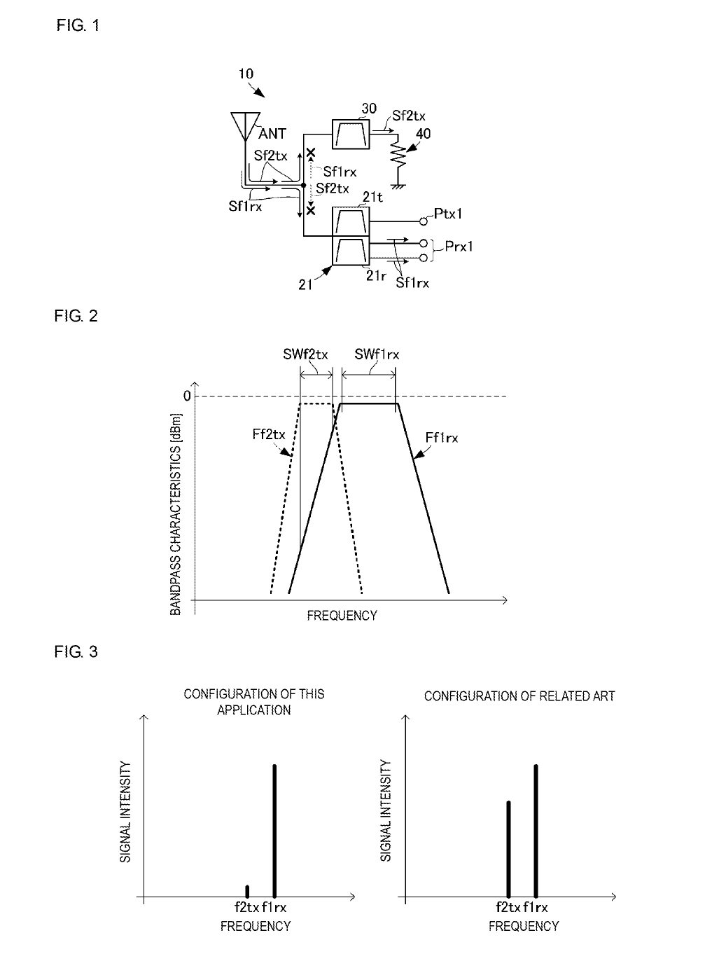

A high-frequency front end circuit according to a first embodiment of the present disclosure will be described with reference to drawings. FIG. 1 is a circuit block diagram of a high-frequency front end circuit according to the first embodiment of the present disclosure. FIG. 2 is a diagram illustrating bandpass characteristics of each filter of the high-frequency front end circuit according to the first embodiment of the present disclosure.

A high-frequency front end circuit 10 according to this embodiment includes a duplexer 21, a filter 30, a terminating resistor 40, an antenna ANT, a first transmission signal input terminal Ptxl, and a first reception signal output terminal Prxl. The duplexer 21 includes a transmission-side filter 21t and a reception-side filter 21r. The reception-side filter 21r corresponds to a “first filter” of the present disclosure, and the filter 30 corresponds to a “second filter” according to the present disclosure.

The antenna ANT is connected to a common terminal of the duplexer 21. That is, the antenna ANT is connected to one end of each of the transmission-side filter 21t and the reception-side filter 21r. The antenna ANT is connected to one end of the filter 30.

The other end of the transmission-side filter 21t is connected to the first transmission signal input terminal Ptx1. The other end of the reception-side filter 21r is connected to the first reception signal output terminal Prx1.

The other end of the filter 30 is connected to the ground with the terminating resistor 40 of 50Ω interposed therebetween.

The transmission-side filter 21t is a band pass filter whose pass band includes a frequency range of a transmission signal having a first frequency band. The reception-side filter 21r is a band pass filter whose pass band includes a frequency range of a reception signal having the first frequency band.

More specifically, as illustrated in FIG. 2, for the reception-side filter 21r, filter characteristics Ff1rx are set such that a frequency range SWf1rx of a reception signal Sf1rx having the first frequency band is included in the pass band.

The filter 30 is a band pass filter whose pass band includes a frequency range of a communication signal having a second frequency band. The filter 30 only needs to be formed in such a manner that at least a frequency range SWf2tx of a transmission signal Sf2tx having the second frequency band is included in the pass band.

More specifically, as illustrated in FIG. 2, for the filter 30, filter characteristics Ff2tx are set such that the frequency range SWf2tx of the transmission signal Sf2tx having the second frequency band is included in the pass band and the frequency range SWf1rx of the reception signal Sf1rx having the first frequency band is included in the attenuation band.

The transmission-side filter 21t, the reception-side filter 21r, and the filter 30 are, for example, formed as SAW filters. It is desirable that the attenuation characteristics at an end of the pass band of the filter 30 are steep compared to the transmission-side filter 21t and the reception-side filter 21r.

As a specific example, the first frequency band is one of Band 7 (reception range: 2620 MHz to 2690 MHz), Band 38 (reception range: 2570 MHz to 2620 MHz), Band 40 (reception range: 2300 MHz to 2400 MHz), and Band 41 (reception range: 2496 MHz to 2690 MHz) of the cellular communication system, and the second frequency band is a band (frequency range: 2400 MHz to 2500 MHz) using the Wifi system.

As described above, the frequency range of the first frequency band and the frequency range of the second frequency band are close to each other. The above combination is an example, and the configuration of the disclosure of this application may be applied to any combination as long as the frequency range of the first frequency band and the frequency range of the second frequency band are close to each other. An example of criteria for closeness of frequency ranges is that at least a part of a communication frequency range of the second frequency band overlaps a transition part to an attenuation range of a filter whose communication range includes the reception frequency range of the first frequency band (a region in which the bandpass characteristics decrease from the pass band with an inclination).

With the high-frequency front end circuit 10 having such a configuration, the reception signal Sf1rx having the first frequency band received at the antenna ANT and the transmission signal Sf2tx having the second frequency band received at the antenna ANT (sneaked into the antenna ANT from the outside) are transmitted as described below.

The reception signal Sf1rx having the first frequency band and the transmission signal Sf2tx having the second frequency band that are received at the antenna ANT are transmitted to a connection point at which the duplexer 21 and the filter 30 are connected.

The pass band of the filter 30 includes the frequency range SWf2tx of the transmission signal (communication signal) Sf2tx having the second frequency band, and the filter 30 is connected to the terminating resistor 40. Therefore, it appears that, with respect to the transmission signal Sf2tx having the second frequency band, impedance matching is obtained on the filter 30 side. In contrast, the pass band of the transmission-side filter 21t and the pass band of the reception-side filter 21r differ from the frequency range SWf2tx of the transmission signal Sf2tx having the second frequency band. Therefore, it appears that, with respect to the transmission signal Sf2tx having the second frequency band, impedance matching is not obtained on the duplexer 21 side.

Accordingly, the transmission signal Sf2tx having the second frequency band is mostly transmitted to the filter 30 and are consumed at the terminating resistor 40. Consequently, the transmission signal Sf2tx having the second frequency band is scarcely transmitted to the duplexer 21 side.

Meanwhile, the pass band of the reception-side filter 21r of the duplexer 21 includes the frequency range SWf1rx of the reception signal Sf1rx having the first frequency band. Therefore, it appears that, with respect to the reception signal Sf1rx having the first frequency band, impedance matching is obtained between the connection point and the reception signal output terminal Prx1. In contrast, the pass band of the filter 30 differs from the frequency range SWf1rx of the reception signal Sf1rx having the first frequency band. Therefore, it appears that, with respect to the reception signal Sf1rx having the first frequency band, impedance matching is not obtained on the filter 30 side.

Accordingly, the reception signal Sf1rx having the first frequency band is transmitted to the reception signal output terminal Prx1 via the reception-side filter 21r of the duplexer 21. Consequently, only the reception signal Sf1rx having the first frequency band, which is a desired communication signal, may be output from the reception signal output terminal Prx1.

FIG. 3 includes diagrams illustrating the concept of a frequency spectrum at the reception signal output terminal Prx1 with a configuration of the disclosure of this application and with a configuration of related art. As illustrated in FIG. 3, with the configuration of the disclosure of this application, the signal level of the transmission signal Sf2tx having the second frequency band which is transmitted to the reception signal output terminal Prx1 may be significantly reduced. Accordingly, the S/N of the reception signal Sf1rx having the first frequency band at the reception signal output terminal Prx1 may be improved.

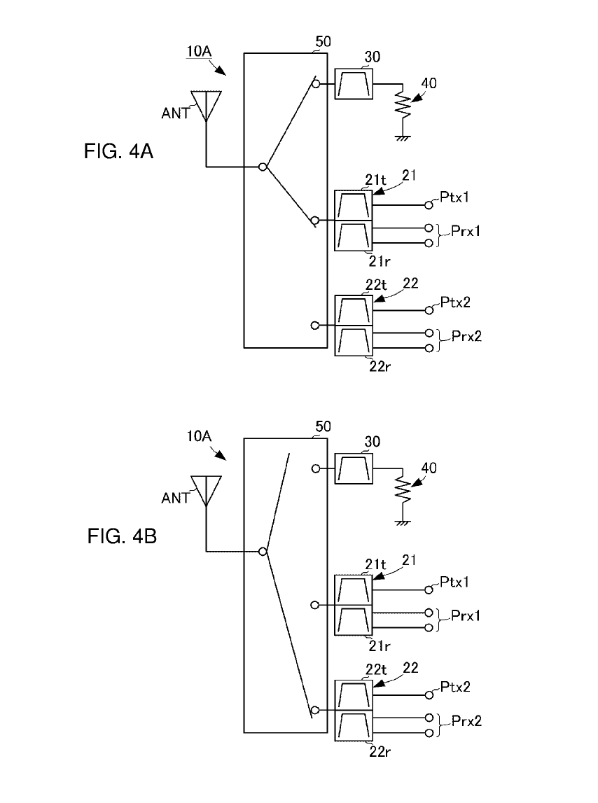

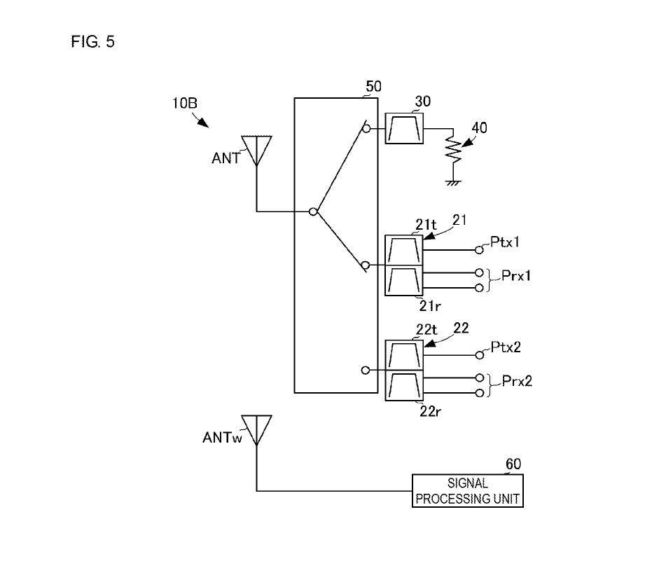

Next, a high-frequency front end circuit according to a second embodiment of the present disclosure will be described with reference to drawings. FIGS. 4A and 4B include circuit block diagrams of the high-frequency front end circuit according to the second embodiment of the present disclosure. FIGS. 4A and 4B illustrate different states of a switch circuit.

A high-frequency front end circuit 10A according to this embodiment is a circuit that includes a switch circuit 50, a duplexer 22, a second transmission signal input terminal Ptx2, and a second reception signal output terminal Prx2, which are added to the high-frequency front end circuit 10 according to the first embodiment. The other configuration features of the high-frequency front end circuit 10A are the same as those of the high-frequency front end circuit 10 according to the first embodiment. Therefore, only differences from the high-frequency front end circuit 10 according to the first embodiment will be specifically described.

The switch circuit 50 includes an antenna connection terminal and multiple individual terminals. The switch circuit 50 has a configuration in which the antenna connection terminal may be connected to one or two individual terminals.

The antenna ANT is connected to the antenna connection terminal of the switch circuit 50. The duplexer 21 is connected to a first individual terminal of the switch circuit 50. The filter 30 is connected to a second individual terminal of the switch circuit 50. The duplexer 22 is connected to a third individual terminal of the switch circuit 50.

The duplexer 22 includes a transmission-side filter 22t and a reception-side filter 22r. The transmission-side filter 22t is set such that the pass band includes a frequency range of a transmission signal having a third frequency band. The reception-side filter 22r is set such that the pass band includes a frequency range having the third frequency band. The third frequency band has, as a communication range, a frequency range which is not close to at least the second frequency band.

The second transmission signal input terminal Ptx2 is connected to the transmission-side filter 22t. The second reception signal output terminal Prx2 is connected to the reception-side filter 22r.

(A) In case where reception signal having first frequency band is received

As illustrated in FIG. 4A, the switch circuit 50 connects the antenna connection terminal to the first individual terminal and the second individual terminal. Accordingly, a circuit configuration similar to the first embodiment is achieved. Consequently, even if a transmission signal having the second frequency band sneaks around via the antenna ANT, only a reception signal having the first frequency band, which is a desired communication signal, may be output from the reception signal output terminal Prx1.

(B) In case where reception signal having third frequency band is received

As illustrated in FIG. 4B, the switch circuit 50 connects the antenna connection terminal only to the third individual terminal. With this circuit configuration, although a transmission signal having the second frequency band and a reception signal having the third frequency band are transmitted to the duplexer 22, the transmission signal having the second frequency band is blocked at the reception-side filter 21r. Consequently, even if the transmission signal having the second frequency band sneaks around via the antenna ANT, only the reception signal having the third frequency band, which is a desired communication signal, may be output from the reception signal output terminal Prx2.

In this embodiment, one duplexer 21 that corresponds to the first frequency band and one duplexer 22 that corresponds to the third frequency band are provided. However, at least one of the duplexer 21 and the duplexer 22 may be provided in a plural number.

Next, a high-frequency front end circuit according to a third embodiment according to the present disclosure will be described with reference to drawings. FIG. 5 is a circuit block diagram of the high-frequency front end circuit according to the third embodiment of the present disclosure.

A high-frequency front end circuit 10B according to this embodiment further includes a transmission/reception circuit unit for the second frequency band, relative to the high-frequency front end circuit 10A according to the second embodiment. The other configuration features of the high-frequency front end circuit 10B according to this embodiment are the same as those of the high-frequency front end circuit 10A according to the second embodiment. Therefore, only differences from the high-frequency front end circuit 10A according to the second embodiment will be specifically described.

The high-frequency front end circuit 10B according to this embodiment includes an antenna ANTw for the second frequency band and a signal processing unit 60 for the second frequency band. The signal processing unit 60 generates a transmission signal having the second frequency band, and performs reception processing for a reception signal. The signal processing unit 60 only needs to have at least a function for generating a transmission signal having the second frequency band.

With this configuration, the antennas ANT for the first and third frequency bands (at least the first frequency band) are extremely close to the antenna ANTw for the second frequency band. Therefore, the transmission signal having the second frequency band transmitted from the antenna ANTw is likely to be received at the antenna ANT at a relatively high level. However, with the use of the above configuration, even with the configuration according to this embodiment, only a reception signal having the first frequency band, which is a desired communication signal, may be output from the reception signal output terminal Prx1.

In each of the foregoing embodiments, an aspect in which a duplexer is used is described. However, by providing at least a reception-side filter of a duplexer, operational advantages of the disclosure of this application may be achieved.

### REFERENCE SIGNS LIST

10, 10A, 10B: high-frequency front end circuit

21, 22: duplexer

21t, 22t: transmission-side filter

21r, 22r: reception-side filter

30: filter

40: terminating resistor

50: switch circuit

60: signal processing unit

ANT, ANTw: antenna

Ptx1: first transmission signal input terminal

Prx1: first reception signal output terminal

Ptx2: second transmission signal input terminal

Prx2: second reception signal output terminal

1. A high-frequency front end circuit comprising:
an antenna that transmits and receives communication signals having multiple frequency ranges;
a first filter that has a pass band including a frequency range of a reception signal having a first frequency band, one end of the first filter being connected to the antenna, the other end of the first filter being connected to a reception signal output terminal; and
a second filter that has a pass band including a frequency range of a communication signal having a second frequency band which is different from the first frequency band and which is used for communication in a frequency range that is close to the frequency range of the first frequency band, one end of the second filter being connected to the antenna, the other end of the second filter being terminated.

2. The high-frequency front end circuit according to claim 1, wherein a frequency range of a transmission signal having the second frequency band is in the pass band of the second filter.

3. The high-frequency front end circuit according to claim 1, further comprising:
a third filter that has a pass band including a frequency range of a communication signal having a third frequency band which is different from the first frequency band and the second frequency band; and
a switch circuit that switches a connection of the antenna between the first filter and the third filter and switches between connection and disconnection of the second filter and the antenna.

4. The high-frequency front end circuit according to claim 3,
wherein the switch circuit connects the second filter to the antenna when the first filter and the antenna are connected.

5. The high-frequency front end circuit according to claim 3,
wherein the switch circuit disconnects the second filter from the antenna when the third filter and the antenna are connected.

6.The high-frequency front end circuit according to claim 1,
wherein the first filter is configured as part of a duplexer.

7. The high-frequency front end circuit according to claim 3,
wherein the first filter and the third filter are configured as part of a duplexer.

8. The high-frequency front end circuit according to claim 1, further comprising:
a second communication antenna that transmits and receives a second communication signal; and
a signal processing unit that generates a transmission signal of the second communication signal.

9. The high-frequency front end circuit according to claim 1,
wherein the first frequency band is from 2620 MHz to 2690 MHz.

10. The high-frequency front end circuit according to claim 1,
wherein the first frequency band is from 2570 MHz to 2620 MHz.

11. The high-frequency front end circuit according to claim 1,
wherein the first frequency band is from 2300 MHz to 2400 MHz.

12. The high-frequency front end circuit according to claim 1,
wherein the first frequency band is from 2496 MHz to 2690 MHz.

13. The high-frequency front end circuit according to claim 1,
wherein the second frequency band is a band which is adopted by a WiFi system.

14. The high-frequency front end circuit according to claim 1,
wherein the other end of the second filter is terminated to ground through a resistor.

15. The high-frequency front end circuit according to claim 1,
wherein a resistance of the resistor is 40 Ohms to 50 Ohms.
